(19) United States
(12) Patent Application Publication
(10) Pub. No.: US 2008/0288551 A1
(43) Pub. Date: Nov. 20, 2008

(54) Method and System for Updating User Profiles

(75) Inventor: Bartel Marinus Van De Sluis, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,011

(22) PCT Filed: Nov. 24, 2006
(86) PCT No.: PCT/IB2006/054416

§ 371 Date: May 27, 2008

(30) Foreign Application Priority Data
Nov. 30, 2005 (EP) 05111488.2

(51) Int. Cl. G06F 17/30

(52) U.S. Cl. 707/200; 707/E17.005

(57) ABSTRACT

The invention relates to a data-processing system comprising a data processor (131) for obtaining description data derived from personal content provided by a user, a storage means (132) for storing the description data in user profile data for selecting other content in accordance with user preferences, wherein the data processor is configured to obtain further description data derived from further personal content provided by the user, and the storage means is adapted to update the user profile data with the further description data. The invention also relates to the data-processing method. The accumulation of the description data in the user profile data enables the user profile to reflect the user preferences in an accurate manner.

The invention relates to a data-processing system comprising a data processor for obtaining description data derived from personal content provided by a user, and a data-processing method comprising the step of obtaining description data derived from personal content provided by a user.

US2003/0078837 discloses a method of providing pre-determined advertisements related to content of photos on a digital disc. A user inserts the disc with the photos in a kiosk for ordering photo prints. The kiosk reads the disc and extracts information from the photo content. For example, events such as a Christmas celebration are detected and classified, using date/time and location of photo captures indicated in metadata of the photos. This information about areas of customer interest is of importance to advertisers. The photos are categorized on the basis of the areas of customer interest. The areas are correlated to the pre-stored advertisements. The matching advertisements are recorded on the disc with the photos.

The known method allows extraction of the information about the areas of user interest from the photos. This information represents valuable knowledge about the user interests because it is extracted from the content that is valuable to the user. The information is subject to privacy and is used only once for adding advertisements to the photos. Therefore, the known method is not suitable for an efficient use of the extracted information.

It is desirable to provide a data-processing system, which is adapted for an efficient use of the description data derived from the personal content provided by the user.

According to the present invention, a data-processing system is provided, which comprises
a data processor for obtaining description data derived from personal content provided by a user,
a storage means for storing the description data in user profile data for selecting other content in accordance with user preferences, wherein
the data processor is configured to obtain further description data derived from further personal content provided by the user, and
the storage means is adapted to update the user profile data with the further description data.

The personal content may be any digital media content that the user provided by e.g. taking photos, drawing pictures on a PC, selecting portions of recorded TV programs. Such personal content usually reflects the user's interest. The data processor is configured to obtain the description data describing the personal content. For example, textual labels are extracted from the photos. Objects and events in the photos are classified and the labels are obtained. For example, the label may comprise one or more keywords corresponding to one or more classified objects like cars, concerts, house, etc.

A user profile is created for storing the obtained description data on the storage means. The description data remain in the system after it is stored in the storage means.

The user profile data are used for selecting other content in accordance with the user preferences identified, using the description data. The selection of the other content may be performed by the system automatically or upon a user command. The selection of such content would be authorized by the user, for example, because the user purposefully uses the system for obtaining the user profile data. The user profile data are used in the interest of the user and not in the interest of another party e.g. desiring to disseminate advertisements. When the user instructs the system to search for the content using the user profile data, the description data may not be transferred to the other party and the user's privacy is respected. On the contrary, when the other party voluntarily extracts the description data and uses it without any authorization of the user, the user's privacy is infringed upon. Thus, the system according to the present invention is technically configured to operate with the description data in the allowable manner.

According to the present invention, the description data extracted from the personal content is used for selection or recommendation of the other content belonging to another content domain. For example, the system selects broadcast digital media content or filters EPG data (Electronic Program Guide data) using the description data. Such an advantageous cross-domain use of the description data allows a considerable amount of effort to be dispensed with for specifying user interests in the other content domain. The user may not be required to specify the preferences manually, e.g. in a TV system, or the TV system may not be required to analyze program selections of the user by TV channel zapping.

The data processor of the data-processing system of the present invention is configured to obtain further description data derived from further personal content provided by the user. The further personal content may be another set of digital photos taken by the user or another user-selected segment of the TV program, etc. The storage means is adapted to update the user profile data with the further description data. The description data and the further description data are aggregated in the user profile data. This accumulation of knowledge about the user preferences in the storage means enables the system to increase the efficiency of future selections of the other content. Whenever new personal content is analyzed and new description data is obtained, the accuracy of the user profile data increases.

The data-processing method of the present invention comprises the steps of:
obtaining description data derived from personal content provided by a user,
storing the description data in user profile data for selecting other content in accordance with user preferences,
obtaining further description data derived from further personal content provided by the user, and
updating the user profile data with the further description data.

The method has the same advantages as the system described above.

These and other aspects of the invention will be further explained and described, by way of example, with reference to the drawing, in which:

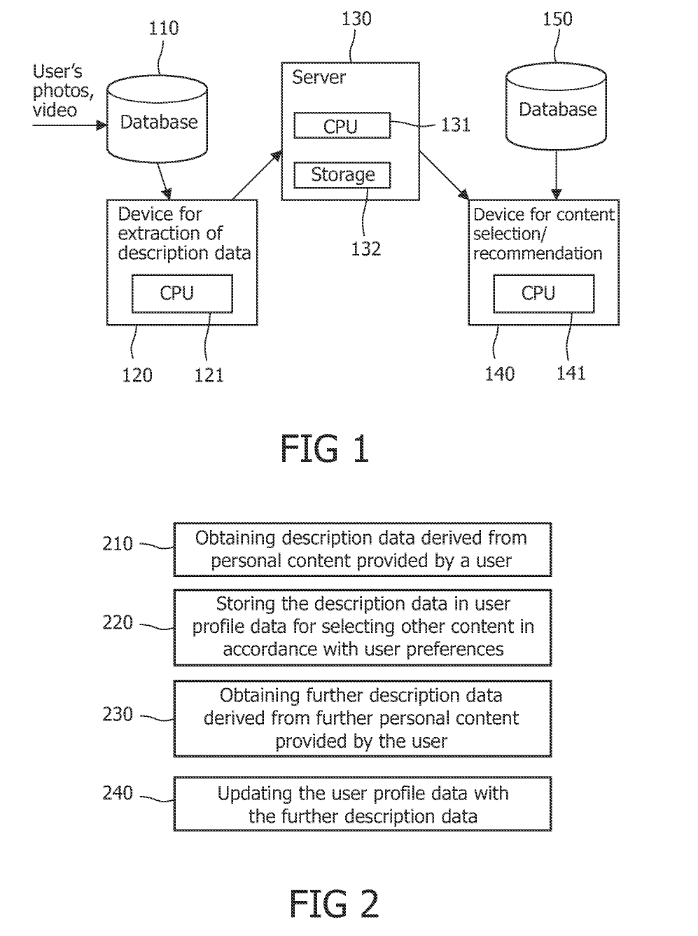

FIG. 1 is a functional block diagram of an embodiment of the system according to the present invention, and

FIG. 2 is an embodiment of the method of the present invention.

Today, a user has a wide variety of consumer electronics (CE) devices at his disposal, with functionalities allowing the user to create his own media content, personalize media content created by someone else by editing the media content, marking up, selecting or editing the media content. The creation of a user's own content or the editing of someone else's media content may be an interesting and enjoyable activity for the user that may result in a considerable amount of photos, TV programs, movies, songs, home video records stored in home CE devices or on a server with a storage space allocated to the user (e.g. to store a photo album). This personal content provided by the user has a significant potential for understanding the user's interests with respect to the media content. For example, information about his interests is implicitly available in (metadata of) digital images captured by the user. The present invention aims at utilizing the information about the user's interests, which is implicitly available from the personal content provided by the user, so as to create a user profile suitable for recommending other media content to the user, e.g. television programs or movies. For example, the information about the user's interests obtained from a personal content domain is used for a public content domain.

FIG. 1 shows an embodiment of a system according to the present invention. The system may comprise a database 110 adapted to store the personal content provided by the user, a content analysis device 120 for performing at least one content analysis method on the personal content stored in the database 110, and a server 130 for communication with the content analysis device 120. For example, the database 110 is utilized for storing one or more digital photos or a video clip taken by the user, and for downloading the photos or the video clip from the user's camera.

The content analysis device 120 may comprise a digital data processor 121 for accessing the personal content in the database 110 and carrying out one or more content analysis methods on the personal content. The execution of the content analysis method may result in a generation of description data representing aspects of the personal content which indicate the user's interest. As an example, the content analysis method may comprise one of or a combination of the following algorithms:

1) a first algorithm is suitable for recognizing a pre-determined video object, e.g. a car, house or a person with whom the user is acquainted, in a still image or video record in the personal content; a keyword corresponding to the video object recognized in the personal content is included in the description data;

2) a second algorithm may allow analysis of position coordinates, e.g. GPS coordinates, related to the personal content, e.g. photos taken with a camera incorporating a GPS receiver, and determination of a name of a (geographical) location corresponding to the position coordinates;

3) in a third algorithm, if a time and/or a date is related to the personal content, e.g. a time/date stamp is attached to the photo, an event, e.g. Christmas or a particular person's birthday, is automatically established and a textual description is determined, e.g. “Christmas” or “Pavel's birthday”; the second and third algorithms are known from WO2005/001714; the combination of the geographical name and the time/date may be matched with a calendar of events so as to yield a name of a particular event in the specific location (e.g. (“Amsterdam Arena”)+(“13 July 2005”)=>“U2 Concert”); thus, metadata, e.g. the time/date stamp, of the personal content may be translated into a high-level semantics description;

4) in a fourth algorithm, a pre-determined audio pattern associated with a particular person, an animal or an object is recognized in an audio personal content; a keyword corresponding to the recognized audio pattern is included in the description data; the fourth algorithm may be advantageously combined with the first, second or third algorithm for increasing a reliability of the recognition, location or event determination.

One or more labels generated by means of the above methods, e.g. the keyword, the location name or the textual description of the event, are collected in the description data. Thus, the generation of the description data may be completely autonomous and no user input may be required. The description data may be stored in the content analysis device 120 or in the database 110. Alternatively, the server 130 may be configured to automatically receive the description data from the content-analysis device 120 without the need for storing the description data in the content analysis device 120. The server 130 is only an embodiment of a data-processing system comprising a digital data processor 131 for obtaining description data derived from the personal content, and a storage means 132 for storing user profile data comprising the description data. The data-processing system may also be a personal set-top box or a suitably programmed home PC. In one embodiment, the data-processing system may additionally incorporate the content analysis device 120 and the database 110. In that case, the processors 121 and 131 may be realized with a single digital data processor.

The storage means of the server 130 may be configured to store a user profile about user preferences. The user profile is a data collection with various information such as keywords, names, titles, summaries, etc. The processor 131 may be configured to cull the description data generated, using one or more content analysis methods, e.g. by the content analysis device 121, from the user profile.

A recommendation device 140 comprising a recommendation data processor 141 may be configured to communicate with the server 130. The recommendation device may have for its purpose to select the content in accordance with the user preferences from an available source of the content, such as a content database 150. For example, the content may be retrieved from the Internet, television broadcast signals e.g. including the EPG data, or a third-party content database. To filter the content, the processor 141 may be configured to utilize the user profile data received from the server 130. For example, the recommendation device 140 may be used for searching EPG metadata available from the database 150 in order to see if a TV program related to the user profile will be broadcast and, if so, the recommendation device may control a video recorder (not shown) to record this TV program. In one embodiment, the server 130, the content analysis device 120 and the recommendation device 140 are functionally incorporated into a single apparatus, e.g. a home media center.

After some time, the database 110 may be supplemented with new personal content provided by the user. For example, after his last holiday trip to a new destination, the user uploaded a set of new photos taken during the trip into the database 110. According to the present invention, the processor 121 is configured to generate further description data derived from the new personal content. These further description data may comprise at least one label containing new keywords, new names of geographical locations which were visited by the user, etc.

The processor 131 of the server 130 may be configured to update the user profile in the storage means 132 with the further description data. Thus, the user profile accumulates the description data every time new personal content is analyzed. The user profile update may be performed in various ways. For example, the further description data are simply added to the user profile data. In another example, the processor 131 is configured to assign a rating to the at least one label in the user profile data. The rating is determined on the basis of a pre-determined criterion related to the personal content and/or the new personal content.

If the label in the further description data is also found in the description data already stored in the user profile data, the processor 131 may be configured to increase the weight of the label in the user profile. For instance, a frequency counter for counting a number of occurrences of the label in the (new) personal content is incremented.

In another embodiment, the personal content has a time attribute, e.g. the time stamp of a creation time/date of a photo taken by the user. When the label is extracted from the (new) personal content, it may also be given the same time attribute. When the processor 131 updates the user profile data with one or more labels, the processor may determine whether the time attribute of one label in the further description data is more recent or later than the time attribute of the label in the description data already present in the user profile data. If the time attribute indicates the recent time, the corresponding label is assigned a higher rating than that label with the later time attribute. The assignment of different ratings depending on the time attribute as the pre-determined criterion allows possible changes in the user's interests to be taken into account. The rating may be used by the recommendation device 140 for prioritizing content items.

The processor 121, 131 or 141 may be a well-known central processing unit (CPU) suitably arranged to implement the present invention and enable the operation of the device 120, 130 or 140, respectively, as explained herein.

The personal content and the other content provided by a party other than the user may comprise at least one of, or any combination of, visual information (e.g. video images, photos, graphics), audio information, text information, and other digital data such as e.g. metadata according to the MPEG-7 standard which may be used to describe and search digitized materials by means of sampling, as well as by using lexical search terms.

The data may be stored in the database 110, the storage means 132 or the database 150 on different data carriers such as audio or video tapes, optical storage discs, e.g. CD-ROM discs (Compact Disc Read Only Memory) or DVD discs (Digital Versatile Disc), floppy and hard-drive disks, etc. in any format, e.g. MPEG (Motion Picture Experts Group), MIDI (Musical Instrument Digital Interface), Shockwave, QuickTime, WAV (Waveform Audio), etc. For example, the storage means 132 may comprise a computer hard-disk drive, a versatile flash memory card, e.g. a “Memory Stick” device, etc. In one embodiment, the database 110 and the storage means 132 are combined. In accordance with an embodiment of the present invention, the storage means 132 are implemented as a database comprising the aggregated user profile data. Whenever the processor 131 obtains new description data, the database is updated.

FIG. 2 shows an embodiment of the method of the present invention. In step 210, the description data derived from the personal content provided by the user are obtained e.g. by the processor 131. The description data are stored in user profile data in step 220. The user profile is adapted to be used by e.g. the recommendation device 140 for selecting content other than the content provided by the user. In step 230, the further description data derived from newly provided personal content by the user are obtained. These further description data are used in step 240 to update the user profile data in order to improve the accuracy of the user profile in reflecting the user preferences. For example, the ratings are assigned to the labels in the user profile data, or the new labels are added to broaden the information about the user's interests. Basically, both steps 210 and 220 are repeated in steps 230 and 240 whenever e.g. new photos or new video records of the user are available. In addition, the user profile is modified.

Variations and modifications of the described embodiment are possible within the scope of the inventive concept. For example, in one embodiment, the system according to the present invention is implemented in a single device, e.g. the server 130, or it comprises a service provider and a client, e.g. the server 130 and the recommendation device 140. Alternatively, the system may comprise devices that are distributed and remotely located from each other.

The processor may execute a software program to enable the execution of the steps of the method of the present invention. The software may enable a device according to the present invention independently of where the device is being run. To enable the device, the processor may transmit the software program to, for example, the other (external) devices. The independent method claim and the computer program product claim may be used to protect the invention when the software is manufactured or exploited for running on consumer electronics products. The external device may be connected to the processor by using existing technologies, such as Blue-tooth, IEEE 802.11[a-g], etc. The processor may interact with the external device in accordance with the UPnP (Universal Plug and Play) standard.

A “computer program” is to be understood to mean any software product stored on a computer-readable medium, such as a floppy disk, downloadable via a network, such as the Internet, or marketable in any other manner. The various program products may implement the functions of the system and method of the present invention and may be combined in several ways with the hardware or located in different devices. The invention can be implemented by means of hardware comprising several distinct elements, and by means of a suitably programmed computer. In the device claim enumerating several means, several of these means can be embodied by one and the same item of hardware.

1. A data-processing system comprising
a data processor (131) for obtaining description data derived from personal content provided by a user,
a storage means (132) for storing the description data in user profile data for selecting other content in accordance with user preferences, wherein
the data processor is configured to obtain further description data derived from further personal content provided by the user, and
the storage means is adapted to update the user profile data with the further description data.

2. The system of claim 1, wherein the description data and/or the further description data comprise at least one label for describing the personal content or the further personal content, respectively.

3. The system of claim 2, wherein the data processor is configured to assign a rating to the at least one label on the basis of a pre-determined criterion related to the personal content and/or the further personal content.

4. The system of claim 3, wherein the criterion is a time attribute of the personal content and/or the further personal content.

5. The system of claim 4, wherein the data processor is configured to assign a high rating to a first label derived from first personal content with a recent time attribute, and a low rating to a second label derived from second personal content with a later time attribute.

6. The system of claim 3, wherein the criterion is a frequency of occurrence of the at least one label in the personal content and/or further personal content, respectively.

7. The system of claim 1, wherein the personal content and/or the further personal content is user-operably created or selected.

8. The system of claim 2, wherein the at least one label comprises one or more words describing an object, location or event in the personal content and/or the further personal content, respectively.

9. The system of claim 1, wherein the data processor is configured to select the other content having metadata matching the user profile data.

10. The system of claim 1, wherein the other content is provided by a party other than the user, for example, broadcast media content.

11. A data-processing method comprising the steps of:
(210) obtaining description data derived from personal content provided by a user,
(220) storing the description data in user profile data for selecting other content in accordance with user preferences,
(230) obtaining further description data derived from further personal content provided by the user, and
(240) updating the user profile data with the further description data.

12. Use of the user profile data of claim 11 for recommending broadcast content.

13. A database (132) comprising the user profile data aggregating the description data and the further description data as in claim 11.

14. A computer program product enabling a programmable device when executing said computer program product to function as the system as defined in claim 1.
